(19) United States
(12) Patent Application Publication
(10) Pub. No.: US 2026/0204241 A1
(43) Pub. Date: Jul. 16, 2026

(54) ADJUSTABLE JOINTS FOR INSTRUMENT STANDS

(71) Applicant: DRUM WORKSHOP, INC., Oxnard, CA (US)

(72) Inventors: Ruben STEINHAUSER, Altusried (DE); Dominik LANDGRAF, Waltenhofen (DE)

(21) Appl. No.: 19/020,929

(22) Filed: Jan. 14, 2025

(51) Int. Cl. G10D 13/10

(52) U.S. Cl. CPC G10D 13/28

(57) ABSTRACT

Adjustable joints for instrument stands according to the present disclosure include a body with a cylindrical hole configured to accept a tube at a first (e.g., top) end and a different tube at a second (e.g., bottom) end. The diameter of the first end of the joint may be adjusted, and thus, different tubes may be accepted by the joint at its top end. The top end diameter may be adjusted by a switch and switch pad system and/or tightening pads that are controlled by a tightening dial configured within the top end.

### BACKGROUND

### 1. Field of the Disclosure

The present disclosure relates generally to tube joints for instrument stands, and, in particular, tube joints with adjustable diameters to allow for connection of tubes of different diameters.

### 2. Description of the Related Art

Instrument stands such as percussion stands typically have at least two tubes that are connected by a tube joint or similar connection component. Prior art tube joints for percussion instrument stands are designed for connection to a lower tube and an upper tube each of a specific, static diameter; that is, even for the same lower tube, different tube joints would be needed to connect the lower tube to upper tubes having different diameters, and vice versa.

Accordingly, there is a present need for a tube joint that is capable of easily adjusting its receiving diameter(s) such that the joint may accept and hold tubes of varying diameters.

### SUMMARY OF THE DISCLOSURE

Disclosed herein are adjustable joints that may accept tubes with different diameters.

One embodiment of an adjustable joint for an instrument stand comprises a body configured with a hole comprising a first end with a first end diameter and a second end with a second end diameter. Each of the first and second ends is configured to receive a respective tube, rod, etc. The joint further includes a switch configured to adjust at least a first portion of the first end diameter between a narrowest diameter and a widest diameter. The joint further includes a tightening mechanism configured to adjust at least a second portion of the first end diameter between the narrowest diameter and the widest diameter.

Another embodiment of an adjustable joint for connecting tubes of a drum stand according to the present disclosure comprises a first end with a first diameter, and a second end with a second diameter coaxial with the first diameter. The first diameter is adjustable between a narrow diameter and a wide diameter so as to accommodate tubes of different diameters.

One embodiment of an instrument stand according to the present disclosure includes a bottom tube or rod and an adjustable joint. The adjustable joint includes a bottom end diameter for accommodating a top portion of the bottom tube or rod. The adjustable joint also includes a top end diameter that is adjustable so as to accommodate a plurality of different tubes or rods having different diameters.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

The features and advantages of the various exemplary embodiments will become apparent from the following detailed description when considered in conjunction with the accompanying drawings. Where possible, the same reference numerals and characters are used to denote like features, elements, components or portions of the inventive embodiments. It is intended that changes and modifications can be made to the described exemplary embodiments without departing from the true scope and spirit of the inventive embodiments described herein as defined by the claims.

FIG. 1 is a top perspective view of one embodiment of an adjustable tube joint according to the present disclosure, connected to a lower tube;

FIG. 2 is a top view of the adjustable tube joint shown in FIG. 1, showing the switch and switch pad mechanism and tightening mechanism set at their widest receiving diameter;

FIG. 3 is a top view of the adjustable tube joint shown in FIG. 1, showing the switch and switch pad mechanism and tightening mechanism set at their narrowest receiving diameter;

FIG. 4 is a top view of the adjustable tube joint shown in FIG. 1, with the cover of the joint removed, showing the switch and switch pad mechanism and the tightening mechanism set at their narrowest receiving diameter;

FIG. 5 is a top view of the adjustable tube joint shown in FIG. 1, with the cover of the joint removed, showing the switch and switch pad mechanism at its narrowest receiving diameter and the tightening mechanism set at its widest receiving diameter; and

FIG. 6 is a top view of the adjustable tube joint shown in FIG. 1, with the cover of the joint removed, showing the switch and switch pad mechanism at its narrowest receiving diameter and tightening mechanism set at its widest receiving diameter.

### DETAILED DESCRIPTION OF THE DISCLOSURE

In the following detailed description, numerous specific details are set forth in order to provide a more thorough understanding of embodiments incorporating features of the present disclosure. However, it will be apparent to one skilled in the art that devices, methods, and assemblies according to the present disclosure can be practiced without necessarily being limited to these specifically recited details.

Embodiments of the disclosure are described herein with reference to illustrations that are schematic illustrations of embodiments of the disclosure. As such, the actual size, components and features can be different, and variations from the shapes of the illustrations as a result, for example, of technological capabilities, manufacturing techniques and/or tolerances are expected. Embodiments of the disclosure should not be construed as limited to the particular shapes or components of the regions illustrated herein but are to include deviations in shapes/components that result, for example, from manufacturing or technological availability. The regions illustrated in the figures are schematic in nature and their shapes are not intended to illustrate the precise shape or functionality of a feature of a device and are not intended to limit the scope of the disclosure. In addition, components may be shown as one unit but may instead be a collection of components or units, or a collection of components or units may exist as one unit.

Throughout this description, the preferred embodiment and examples illustrated should be considered as exemplars, rather than as limitations on the present disclosure. As used herein, the term “disclosure,” “device,” “assembly,” “system” “method,” “present disclosure,” “present device” or “present method” refers to any one of the embodiments of the disclosure described herein, and any equivalents. Furthermore, reference to various feature(s) of the “disclosure,” “device,” “assembly,” “system,” “method,” “present disclosure,” “present device” or “present method” throughout this document does not mean that all claimed embodiments or methods must include the referenced feature(s).

It is also understood that when an element or feature is referred to as being “on” or “adjacent” another element or feature, it can be directly on or adjacent to the other element or feature, or intervening elements or features may also be present. It is also understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present unless expressly noted (e.g., a first element could be “directly connected” to a second element by a connector or adhesive, for example).

Relative terms such as “outer,” “inner,” “upper,” “above,” “lower,” “below,” “horizontal,” “vertical,” “top,” “bottom,” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

The term “tube” is used throughout this disclosure most often in conjunction with descriptions of a circular, hollow tube. However, it should be understood that the present description could be applied to noncircular and/or non-hollow elements (e.g., rods), as would be understood by one of skill in the art. Moreover, the term “diameter” is used throughout this description most often in conjunction with descriptions of a circular tube or aperture, but it should be understood that this term could be applied to noncircular elements as well, such as to refer to the smallest or largest side or diagonal dimension of an element (e.g., a side of a rectangle, or a corner-to-corner of a rectangle).

Additionally, the phrases “tube joint” and/or “joint” are used herein typically in describing embodiments where the tube joint or joint is a separate element from the elements it is connecting. However, it should be understood that a tube joint or joint could also be incorporated into one of the elements, e.g., into a top portion of a lower tube, a bottom portion of an upper tube, both of these, and/or other embodiments as would be understood by one of skill in the art.

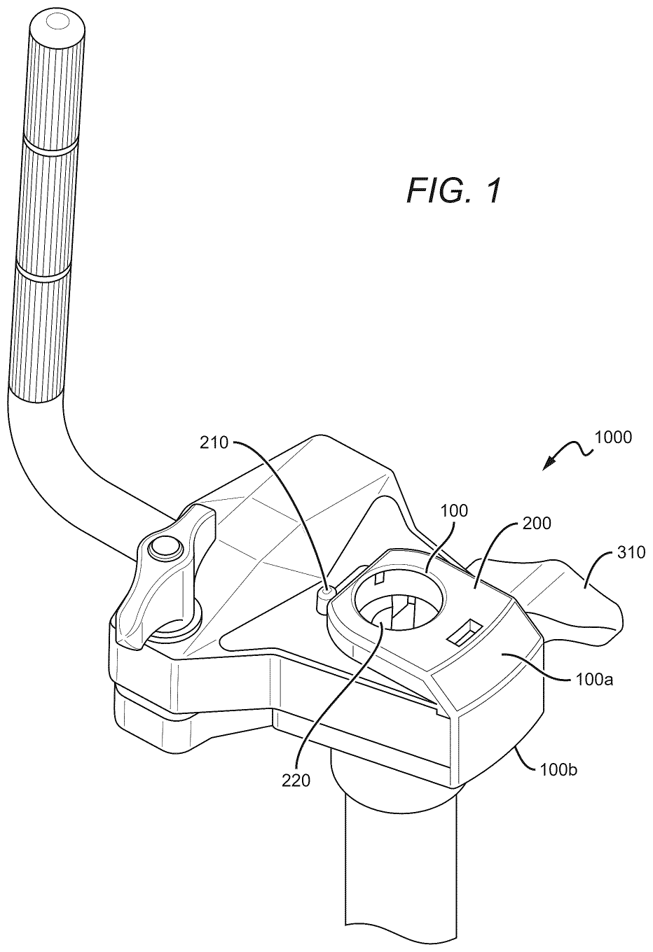

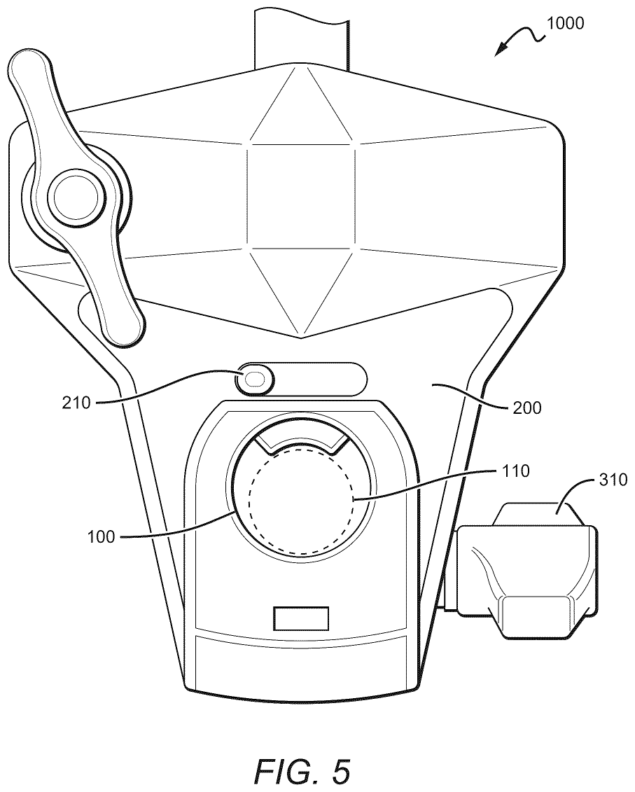

FIGS. 1-7 show one embodiment of an adjustable tube joint 1000 according to the present disclosure. The embodiment shown includes a body with a hole 100 with a top end 100a and a top end diameter 110 and a bottom end 100b. The term “hole” as used herein should be understood to cover a hole that is continuous from top to bottom, and also to cover top and bottom hole portions that are partially or completely divided from one another and may be coaxial. The top end diameter 110 represents the diameter of a tube that may be accepted into the top end 100a of the joint 1000 (an “upper tube”). In embodiments of the present disclosure specifically shown and described, the top end diameter 110 is generally adjustable. It should be understood that the same concept could be applied to tube joint having an adjustable bottom end diameter, whether by itself or in conjunction with an adjustable top end diameter. The bottom end diameter may be larger than narrowest top end diameter, larger than the widest top end diameter, and/or equal to the widest top end diameter; though it should be understood that other embodiments are possible. The adjustable tube joint 1000 further comprises a switch 210 that adjusts the top end diameter 110. The switch 210 shown in FIGS. 1-7 toggles the top end diameter 110 between ½″ and ¾″. However, it should be understood that the top and bottom diameters referred to herein, at their smallest diameter, largest diameter, and/or intermediate diameter(s), can be of varying size as would be understood by one of skill in the art, including but not limited to 1/10″, ¼″, ⅓″, ⅜″, ½″, ⅝″, ¾″, ⅞″, 1″, and ranges between any of these. Moreover, while the switch 210 includes only two set diameters, it should be understood that the embodiment described could be altered for three or more diameters (e.g., a narrowest diameter, a widest diameter, and one or more intermediate diameters). Finally, while the word “diameter” is used herein, the word “diameter” and the present disclosure should be understood to also refer to non-circular embodiments (e.g., ovals, squares, regular polygons, and irregular polygons). It should also be understood that while embodiment discussed in detail herein refers to a joint 1000 with an adjustable top end diameter 100, similar tube/pipe joints with bottom end adjustment (whether by itself or in conjunction with top end adjustment) are envisioned.

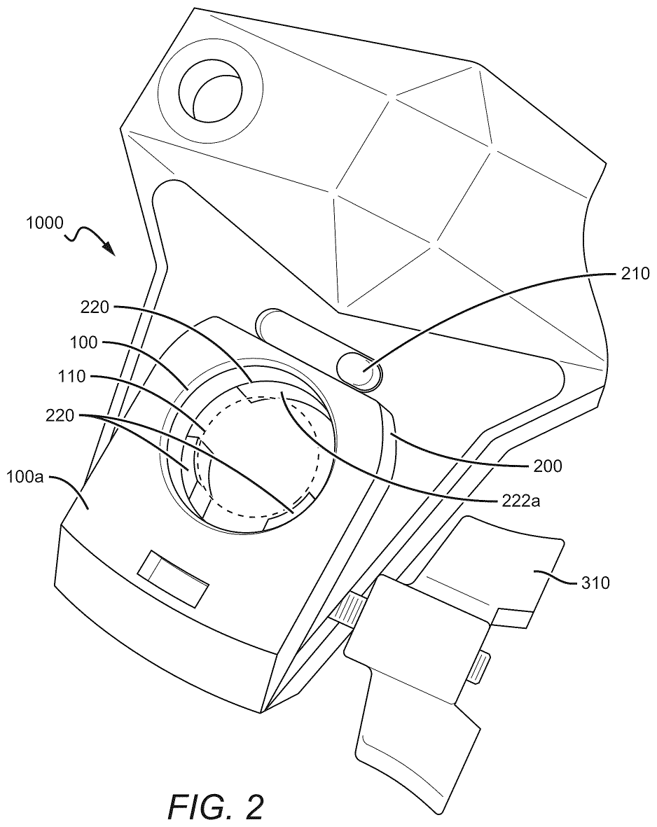

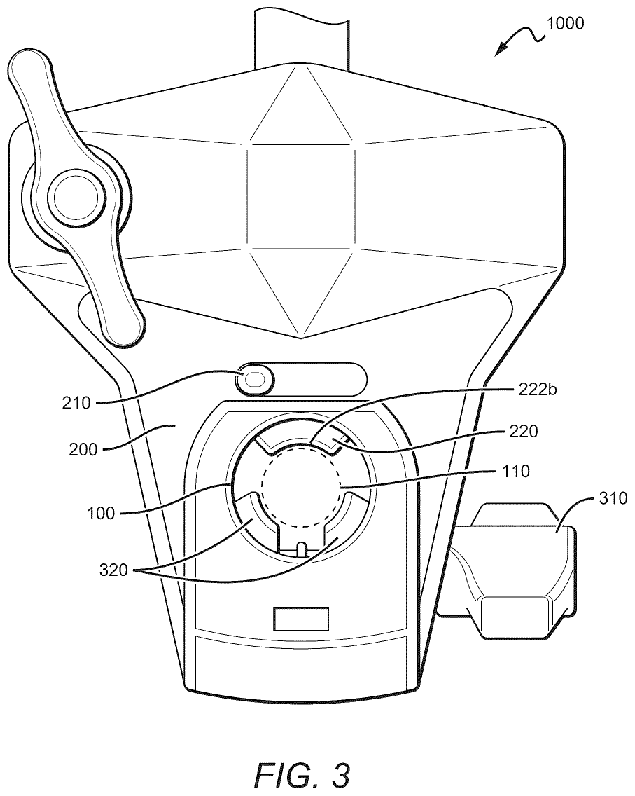

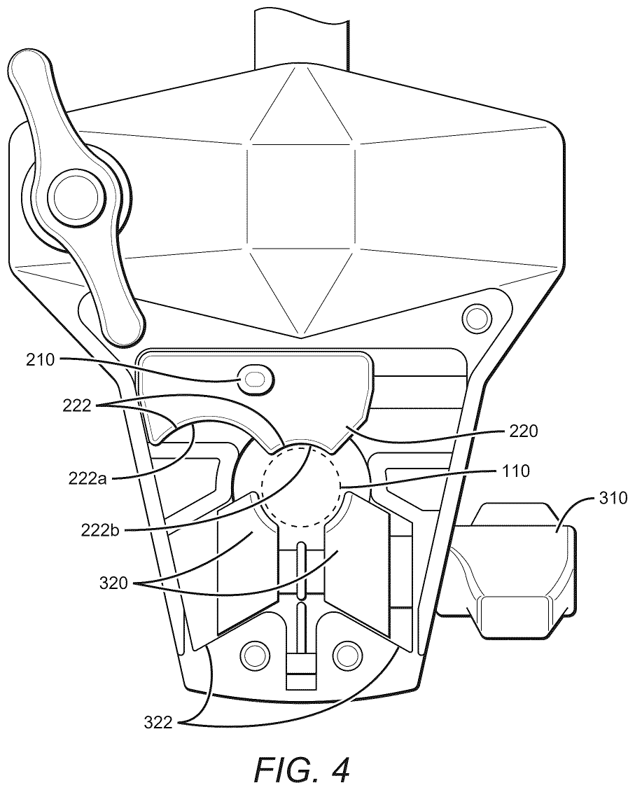

In the embodiment shown in FIGS. 1-7, the switch 210 controls a switch pad 220 situated within the top end 100a. The switch pad 220 is toggled by the switch 210 within the top end 100a to adjust the top end diameter 110. For example, as best shown in FIG. 2, when the switch 210 is set to the widest diameter, the switch pad 220 is not visible and does not interact with any tube that is inserted into the top end 110a. As such, the operative diameter (i.e., top end diameter 110) of the joint 1000 is the same as the diameter of the hole 100. And, as shown in FIGS. 3-4, when the switch 210 is toggled to the narrower diameter, the switch pad 220 is moved into the top end 110a and is configured to adjust the top end diameter 110 to the narrower diameter in that position.

One embodiment of an adjustable tube joint 1000 according to the present disclosure also includes a tightening mechanism 310,320 configured to incrementally adjust part of top diameter 110 (though it should be understood that other embodiments where one, two, or more tightening mechanisms are used to adjust the entire diameter are possible). A tightening mechanism may be comprised of at least two tightening pads 320 coupled with and controlled by a tightening dial 310 (which may comprise, e.g., a wingnut, screw, connector, etc.). FIGS. 2-6 show an embodiment of a tightening mechanism comprised of two tightening pads 320 situated within the top end 100a of the cylindrical hole 100. The two tightening pads 320, controlled by the tightening dial 310, may move incrementally move towards the center of the hole 100, thus narrowing the top end diameter 110, or may move incrementally away from the center of the hole 100, thus expanding the top end diameter 110.

In the embodiment shown in FIGS. 2-6, the tightening dial 310 incrementally moves the two tightening pads 320 simultaneously. However, it is possible for the tightening dial 310 to incrementally move one pad at a time. It is also possible for a different number of tightening pads 320 to be used. For example, 1 or 3 tightening pads are possible. Additionally, it should be understood that the tightening pads 320 could be used without the switch pad 220. For example, two or more tightening pads 320 could be used to form an operative and/or complete top diameter 110.

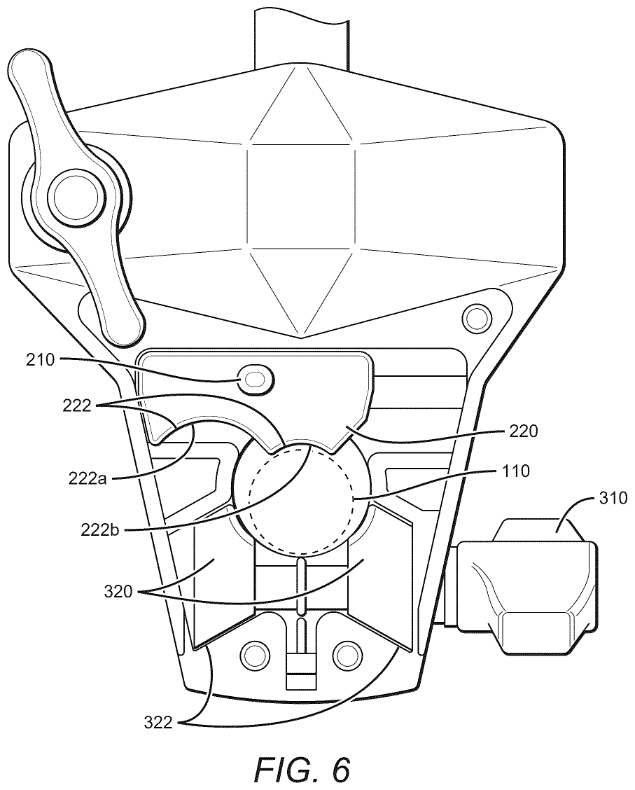

FIGS. 4 and 6 show top views of the adjustable tube joint 1000 with the switch pad 220 set to its narrowest setting but with the two tightening pads 320 controlled by the tightening dial 310 at their narrowest setting (FIG. 4) and at their widest setting (FIG. 6) with the cover 200 of the joint 1000 removed. As shown, the switch 210 moves the switch pad 220 between two positions within a channel. In the position shown in FIG. 4, the switch pad 220 narrows the diameter 110 of the top end 100a. as best seen in FIG. 4, the switch pad 220 can include an arc 222 corresponding to each diameter; in this case, an arc 222a corresponding to the widest diameter 110 and an arc 222b corresponding to the narrowest diameter 110. It should be understood that additional arcs are possible.

Also as shown, the tightening dial 310, which may move linearly, can move the two tightening pads 320 inward and outward with respect to the diameter, such as along ramps 322. The ramps 322 shown are angled at 120 degrees due to three pads (i.e., the switch pad 220 and two tightening pads 320) being used, but it is understood that other angles, numbers of pads, and types of pads are possible. The ramp angle and the two tightening pads 320 cooperate to ensure that the center of the diameter 110 of the top end 100a aligns with the center of the hole 100.

It is understood that embodiments presented herein are meant to be exemplary. Although the present disclosure has been described in detail with reference to certain preferred configurations thereof both in the specification and in the claims, other versions are possible. Embodiments of the present disclosure can comprise any combination of compatible devices/features described herein and/or shown in the figures, and these embodiments should not be limited to those expressly illustrated and discussed. For instance and not by way of limitation, the appended claims could be modified to be multiple dependent claims so as to combine any combinable combination of elements within a claim set, or from differing claim sets. Claims depending on one independent claim could be modified so as to depend from a different independent claim. Therefore, the spirit and scope of the disclosure should not be limited to the versions described above.

While the foregoing written description of the disclosure enables one of ordinary skill to make and use what is considered presently to be the best mode thereof, those of ordinary skill will understand and appreciate the existence of variations, combinations, and equivalents of the specific embodiments, methods, systems, and examples herein. The disclosure should therefore not be limited by the above described embodiments, methods, systems, and examples. Furthermore, certain terminology has been used for the purposes of descriptive clarity, and not to limit the present disclosure. It is therefore intended that the following appended claims include all such alterations, modifications and permutations as fall within the true spirit and scope of the present disclosure. No portion of the disclosure is intended, expressly or implicitly, to be dedicated to the public domain if not set forth in the claims.

We claim:

1. An adjustable joint for an instrument stand, comprising:
a body configured with a hole comprising a first end with a first end diameter and a second end with a second end diameter, wherein said first and second ends are each configured to receive a respective tube;
a switch configured to adjust at least a first portion of said first end diameter between a narrowest diameter and a widest diameter; and
a tightening mechanism configured to adjust at least a second portion of said first end diameter between said narrowest diameter and said widest diameter.

2. The adjustable joint of claim 1, wherein said tightening mechanism comprises:
at least two tightening pads; and
a tightening dial configured to incrementally move said two tightening pads to narrow or expand said first portion of said first end diameter.

3. The adjustable joint of claim 1, wherein said tightening dial is configured to move said two tightening pads simultaneously.

4. The adjustable joint of claim 1, wherein said narrowest diameter and said widest diameter are both between 0.25″ to 1.5″.

5. The adjustable joint of claim 1, wherein said switch is configured to adjust said first portion of said first end diameter between 0.5″ and 0.75″.

6. The adjustable joint of claim 1, wherein said second end diameter is static.

7. The adjustable joint of claim 6, wherein said second end diameter is larger than said widest diameter.

8. The adjustable joint of claim 1, wherein said second end diameter is adjustable.

9. The adjustable joint of claim 1, wherein said adjustable joint is an integral part of a tube.

10. The adjustable joint of claim 1, wherein said hole is continuous.

11. The adjustable joint of claim 1, wherein said switch is configured to adjust at least said first portion of said first end diameter between said narrowest diameter, said widest diameter, and one or more intermediate diameters, wherein said one or more intermediate diameters are between said narrowest diameter and said widest diameter; and
wherein said tightening mechanism is configured to adjust at least said second portion of said first end diameter between said narrowest diameter, said widest diameter, and said one or more intermediate diameters.

12. The adjustable joint of claim 1, wherein said switch is attached to a switch pad, said switch pad comprising a first arc corresponding to said narrowest diameter and a second arc corresponding to said widest diameter, wherein said switch is operable to toggle which of said first and second arcs is in said hole to form said first portion of said first end diameter.

13. The adjustable joint of claim 12, wherein said tightening mechanism comprises at least two tightening pads and a tightening dial, said tightening dial configured to incrementally move said two tightening pads toward said switch pad so as to tighten a first tube against said first arc when said first end diameter is at its narrowest diameter, and so as to tighten a second tube against said second arc when said first end diameter is at its widest diameter.

14. The adjustable joint of claim 1, wherein said first end is a top end and said second end is a bottom end.

15. An adjustable joint for connecting tubes of a drum stand, said adjustable joint comprising:
a first end with a first diameter; and
a second end with a second diameter coaxial with said first diameter;
wherein said first diameter is adjustable between a narrow diameter and a wide diameter so as to accommodate tubes of different diameters.

16. The adjustable joint of claim 15, wherein said first end is a top end.

17. An instrument stand, comprising:
a bottom tube or rod; and
an adjustable joint comprising:
a bottom end diameter for accommodating a top portion of said bottom tube or rod; and
a top end diameter, wherein said top end diameter is adjustable so as to accommodate a plurality of different top tubes or rods having different diameters.

18. The instrument stand of claim 17, wherein said top portion of said bottom tube or rod is in said bottom end diameter.

19. The instrument stand of claim 18, further comprising a to tube or rod, wherein a bottom portion of said top tube or rod is in said top end diameter.
